(19) United States
(12) Patent Application Publication
(10) Pub. No.: US 2013/0293144 A1
(43) Pub. Date: Nov. 7, 2013

(54) LIGHT SOURCE LIGHTING DEVICE AND LUMINAIRE

(71) Applicants: Sayaka Tomiyama, Kanagawa (JP); Masahiko Kamata, Kanagawa (JP); Toshihiko Sasai, Kanagawa (JP); Hitoshi Kawano, Kanagawa (JP); Naoko Iwai, Kanagawa (JP); Masatoshi Kumagai, Kanagawa (JP); Toru Ishikita, Kanagawa (JP); Horomichi Nakajima, Kanagawa (JP)

(72) Inventors: Sayaka Tomiyama, Kanagawa (JP); Masahiko Kamata, Kanagawa (JP); Toshihiko Sasai, Kanagawa (JP); Hitoshi Kawano, Kanagawa (JP); Naoko Iwai, Kanagawa (JP); Masatoshi Kumagai, Kanagawa (JP); Toru Ishikita, Kanagawa (JP); Horomichi Nakajima, Kanagawa (JP)

(73) Assignee: TOSHIBA LIGHTING & TECHNOLOGY CORPORATION, Yokosuka-shi (JP)

(21) Appl. No.: 13/884,940

(22) PCT Filed: Nov. 9, 2011
(86) PCT No.: PCT/JP2011/075826

§ 371 Date: Jul. 24, 2013

(30) Foreign Application Priority Data
Nov. 12, 2010 (JP) 2010-254317

(51) Int. Cl. H05B 33/08

(52) U.S. Cl. CPC H05B 33/0857
USPC 315/294

(57) ABSTRACT

A light source lighting device includes a first light source 1, a second light source 2 having a color temperature lower than a color temperature of the first light source, the color temperature of the second light source being 2500 to 3200 K, a lighting circuit 3 configured to light each of the first and second light sources, and a control unit 4 which is capable of selecting a fadeout mode for continuously dimming and fading out both the first and second light sources and, when the fadeout mode is selected, in a period of a latter stage controls the lighting circuit to increase a light amount of the second light source to be larger than a light amount of the first light source.

### TECHNICAL FIELD

The present invention relates to a light source lighting device that dimmably lights a light source and a luminaire including the light source lighting device.

### BACKGROUND ART

Lighting a plurality of kinds of light sources having different color temperatures, mixing optical outputs of the light sources, and obtaining an optical output having an intermediate color temperature is referred to as toning. Changing the light outputs of the light sources is referred to as dimming. A light source lighting device can be configured to be capable of performing both of the toning and the dimming. It is possible to change a color temperature of lighting during high-illuminance lighting and a color temperature of lighting during low-illuminance lighting using such a light source lighting device.

### BRIEF DESCRIPTION OF THE DRAWINGS

FIG. 1 is a circuit block diagram of a light source lighting device according to a first embodiment of the present invention.

FIG. 2 is a graph showing a relation between time and brightness of a fade mode of first and second light sources in the first embodiment.

FIG. 3 is a graph showing a relation between time and brightness of a fade mode of first and second light sources in a second embodiment of the present invention.

### DESCRIPTION OF EMBODIMENTS

A light source lighting device according to an embodiment includes first and second light sources, a lighting circuit, and a control unit. The second light source has a color temperature lower than a color temperature of the first light source. The color temperature of the second light source is 2500 to 3200 K. The lighting circuit lights each of the first and second light sources. The control unit has a fadeout mode, for continuously dimming and fading out both the first and second light sources, and including periods of a former stage and a latter stage which controls the lighting circuit to increase a light amount of the second light source to be larger than a light amount of the first light source.

### First Embodiment

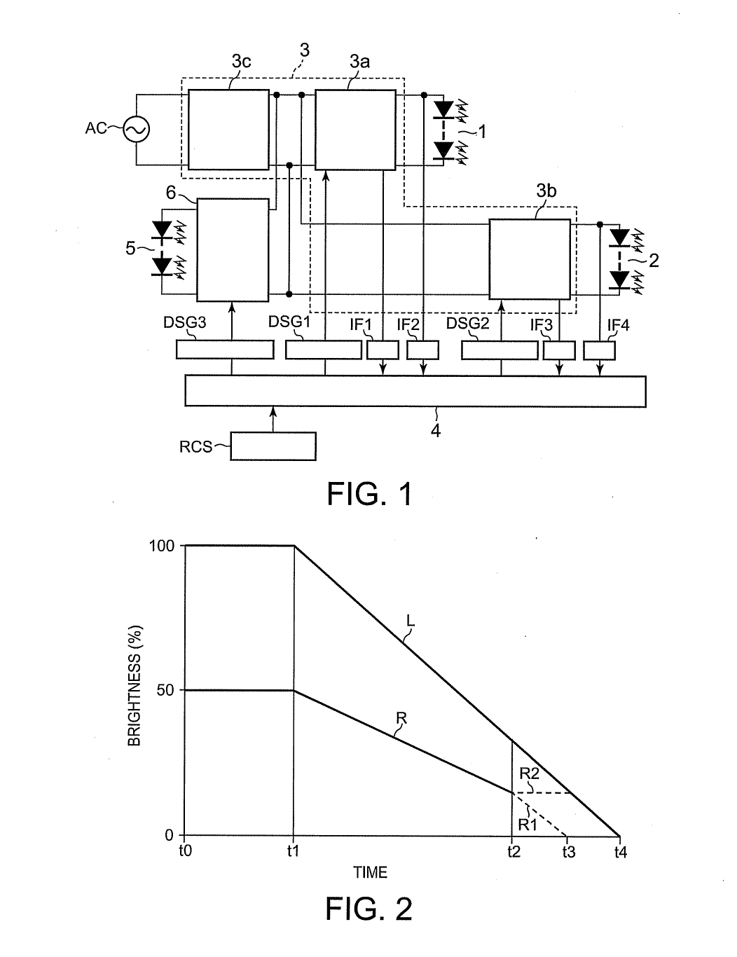

A first embodiment is explained with reference to FIG. 1. In the first embodiment, the light source lighting device includes a first light source 1, a second light source 2, a lighting circuit 3, a control unit 4, an auxiliary lamp 5, and an auxiliary lamp lighting circuit 6.

The first light source 1 has a relatively high color temperature of an optical output thereof. For example, the color output is natural white (in a range of 4600 to 5400 K) having a correlated color temperature of about 5000 K. The color temperature may be obtained by a single light source or may be obtained by subjecting emitted lights of a plurality of light sources having different chromaticities to additive light mixing. When a predetermined color temperature is obtained using the plurality of light sources, types of the light sources may be the same type or a combination of different types.

The second light source 2 has a relatively low color temperature of an optical output thereof. For example, the color output is a light bulb color (in a range of 2500 to 3200 K) having a correlated color temperature of about 2800 K. As in the first light source 1, the color temperature may be obtained by a single light source or may be obtained by subjecting emitted lights of a plurality of light sources having different chromaticities to additive mixture of color stimuli.

Types of the first and second light sources 1 and 2 may be any types. For example, the first and second light sources 1 and 2 may be any lamps such as a fluorescent lamp, an HID lamp, an LED, an EL (organic or inorganic), and a field emission lamp. The types may be the same type or a combination of different types as long as color temperatures of the light sources 1 and 2 are substantially the same. In the embodiment shown in the figure, LEDs are used.

The numbers of the first and second light sources 1 and 2 are not particularly limited. Therefore, one each of the first and second light sources 1 and 2 or an arbitrary plurality of each of the first and second light sources 1 and 2 can be used as appropriate. The numbers of the first light sources 1 and the second light sources 2 may be equal or may be unequal. Note that, in the embodiment shown in the figure, a plurality of LEDs having the same color temperature are, for example, connected in series and used.

Further, mixed light colors having various color temperatures can be obtained by mixing optical outputs of the first and second light sources 1 and 2 and changing a color mixing ratio of the light outputs. For example, illumination light of warm white (in a range of 3200 to 3700 K) having a correlated color temperature of about 3500 K located in the middle of the natural white and the light bulb color can be obtained.

The lighting circuit 3 includes a first lighting circuit element 3a for the first light source 1 and a second lighting circuit element 3b for the second light source 2 in order to light the first and second light sources 1 and 2 separately from each other and, depending on a lighting mode, in synchronization with each other. The lighting circuit 3 includes a common direct-current power supply 3c configured to supply direct-current power to the first lighting circuit element 3a and the second lighting circuit element 3b.

The first and second lighting circuit elements 3a and 3b can continuously dimmably light the first and second light sources 1 and 2. The first and second lighting circuit elements 3a and 3b continuously dim the first and second light sources 1 and 2 in synchronization with each other according to the control by the control unit 4 explained below. However, when desired, the first and second lighting circuit elements 3a and 3b can be set asynchronous and switched to light one or both of the first and second light sources 1 and 2.

A specific circuit system of the lighting circuit 3 is not particularly limited in this embodiment. Therefore, an appropriate circuit corresponding to the type of the light sources can be adopted. When LEDs are used as a representative example of the light sources 1 and 2, a direct-current lighting system is used. As a circuit system in this case, a circuit configuration for desirably subjecting a DC-DC converter, for example, a falling-voltage chopper to constant current control is adopted. Consequently, it is possible to obtain the lighting circuit 3 that has high circuit efficiency and is easily controlled.

The control unit 4 can at least select lighting in a fadeout mode including periods of a former stage and a latter stage for continuously dimming the first and second light sources 1 and 2 in synchronization with each other and fading out both the first and second light sources 1 and 2. When the fadeout mode is selected, the control unit 4 controls the lighting circuit 3 to increase a light amount of the second light source 2 to be larger than a light amount of the first light source 1 in the period of the latter stage. Note that, in this case, the light amount of the first light source 1 is meant to include an extinguished state. To continuously dim both the first and second light sources 1 and 2 in synchronization with each other means to continuously dim both the light sources 1 and 2 under substantially equal optical outputs in the period of the former stage or a period of an intermediate stage of the fadeout mode.

The fadeout mode is plainly expressed as a “sleep timer” and is, for example, a mode of a slow dimming operation for slowly reducing the illuminance of a room light in about 30 minutes to 1 hour to fade out the room light. When this operation mode is introduced, it is possible to reduce the ambient illuminance while suppressing a person from feeling unpleasant.

To increase the light amount of the second light source 2 to be larger than the light amount of the first light source 1 in the period of the latter stage of the fadeout mode means to increase the light amount of the second light source 2 to be larger than the light amount of the first light source 1 in about 10 minutes in the latter half of the fadeout mode period set to, for example, about 30 minutes. In the period of the latter stage of the fadeout mode, the light outputs of the first and second light sources 1 and 2 relatively decrease and the first and second light sources 1 and 2 darken. If the color temperature of illumination at such time is reduced, a sense of composure and a sense of comfort are considered to be given to the person. Therefore, it is possible to obtain an effect of facilitating natural sleep of the person and suppressing the person from awaking from a sleeping state.

The period of the latter stage of the fadeout mode is set in proportion to the time of the fadeout mode. The time of the period may be set to, for example, time of about ⅓ of the entire period of the fadeout mode. The time of the period may be set to a fixed time, for example, about 10 minutes irrespective of the length of the time of the fadeout mode.

Means for increasing the light amount of the second light source 2 to be larger than the light amount of the first light source 1 is not particularly limited in this embodiment. For example, when the dimming of the fadeout mode proceeds to the period of the latter stage, the optical output of the first light source 1 is continuously dimmed and reduced to a dimming lower limit, for example, a dimming degree of 1% before the dimming reaches the end of the fadeout mode, for example, in the time of the former half of the latter stage. In a period of time of the latter half of the latter stage, the optical output is maintained to be fixed at the dimming lower limit or the first light source 1 is extinguished. On the other hand, the optical output of the second light source 2 is fixedly maintained at a fixed level in the period of the former half of the latter stage. In the period of the latter half, the dimming is performed until the end of the fadeout mode. At the end of the fadeout mode, the optical output is maintained at the dimming lower limit or the second light source 2 is extinguished.

The first embodiment is explained with reference to FIG. 2. FIG. 2 is a graph showing a relation between time and brightness of the fadeout mode in the case of a thirty-minute course of the first and second light sources 1 and 2. On the abscissa, time t1 is start time of the fadeout mode, time t2 is start time of the period of the latter stage of the fadeout mode, t3 is boundary time between the former half and the latter half of the period of the latter stage, and t4 is end time of the period of the latter stage of the fadeout mode. The ordinate indicates the brightness of a luminaire. When the brightness is 100%, the first and second light sources 1 and 2 respectively equally share an optical output of 50%. Thereafter, the optical output linearly decreases at the same sharing ratio until the time t2.

In FIG. 2, in a period of normal lighting from time t0 to the time t1, as indicated by a graph L, the luminaire is in a lighting state with a fixed output at the brightness of 100% in the figure. However, in this period, the luminaire can be set to a brightness level corresponding to the preference of a user. After the time t1, the luminaire enters the fadeout mode for 30 minutes. When the luminaire enters the fadeout mode, as indicated by a graph R, the first and second light sources 1 and 2 perform continuous dimming in synchronization with each other. The optical output gradually linearly decreases from 50%. At the time t2, the fadeout mode reaches the latter stage period of 10 minutes in the fadeout mode. In the period explained above, the optical output of the luminaire assumes a light color of warm white located in the middle of the natural white and the light bulb color through light mixing.

When the fadeout mode enters the period of the latter stage indicated by the times t2 to t4, in the first light source 1, as indicated by a long dotted line R1 in the figure, a decrease ratio of the optical output increases and the optical output reaches the dimming lower limit in 5 minutes of the former half. Thereafter, the light output maintains the dimming lower limit until the end.

On the other hand, in the second light source 2, when the fadeout mode enters the period of the latter stage, as indicated by a short dotted line R2 in the figure, a decrease ratio of the optical output is maintained at a value smaller than the decrease ratio of the first light source in 5 minutes in the former half indicated by the times t2 and t3. In 5 minutes of the latter half indicated by the times t3 and t4, the decrease ratio of the optical output increases to be the same as the decrease ratio of the luminaire. At the end time t4 of the fadeout mode, the optical output reaches the dimming lower limit of about 1%.

Therefore, in the figure of the luminaire in the period of the latter stage of the fadeout mode indicated by the times t2 to t4, the optical output of a solid line indicated by the graph L decreases to the dimming lower limit at a gradient same as a gradient in the period before the latter stage. Thereafter, the luminaire is extinguished. However, in the optical output of the luminaire in the period of the former half of the latter stage of the fadeout mode, since a mixing light ratio of the optical output of the second light source 2 increases, the color temperature of the optical output decreases to be lower than the color temperature before the period. In the latter half period of the latter stage, the color temperature further decreases to be equal to the color temperature of the second light source 2.

The control unit 4 can be configured mainly by digital devices such as a microcomputer and a DSP (digital signal processor) in order to facilitate control for subjecting emitted lights of the first and second light sources 1 and 2 to additive mixture of color stimuli and obtaining a light color having a desired correlated color temperature. In the embodiment shown in FIG. 1, the control unit 4 is configured mainly by a microcomputer and is configured to be capable of receiving a remote controller signal RCS. By using a remote controller, it is possible to perform desired toning and dimming through manual remote control by the user or operation in an operation unit disposed on the wall surface and easily select control operation for the fadeout mode and the like.

In the embodiment shown in FIG. 1, reference signs IF1 to IF4 denote interface circuits. The interface circuits are current feedback interfaces IF1 and IF3 of the first and second lighting circuit elements and voltage feedback interfaces IF2 and IF4 of the first and second lighting circuit elements. Reference sign DSG1 denotes a driving signal generating circuit that drives a switching element of the first lighting circuit element 3a. Reference sign DSG2 denotes a driving signal generating circuit that drives a switching element of the second lighting circuit element 3b.

The remote control performed using the remote controller is explained. The remote controller is means for remotely controlling the luminaire from a position away from the luminaire. A specific configuration of the remote controller is not particularly limited. However, the remote controller includes a remote controller operation unit and a remote controller receiver. In the remote controller, in general, a wireless system is adopted. However, a wired system may be adopted when desired. In the case of the wireless system, in general, an infrared ray is used as a communication medium. However, various known media such as a radio wave can also be used as the communication medium.

The remote controller operation unit is, for example, means for controlling the first and second light sources 1 and 2 and the like at hand of the user. The remote controller operation unit is operated in a position away from the luminaire. In the case of dimming, the remote controller operation unit can set a level of the dimming to be adjustable according to the preference of the user and select the fadeout mode as, for example, a so-called “sleep timer”. Therefore, in the remote controller operation unit, for example, operation switches such as a full-light lighting switch, a dimming lighting switch, an extinguishing switch, and the sleep timer and an up-switch and a down-switch for changing the dimming level can be disposed.

The remote controller receiver configures a part of the control unit 4 and is disposed on the luminaire side. The remote controller receiver receives and demodulates the remote controller signal RCS shown in FIG. 1 modulated by an operation signal transmitted from the remote controller operation unit and controls to input the remote controller signal RCS to a main body portion of the control unit 4. Therefore, in the case of wireless, at least a receiving unit of the remote controller receiver is arranged in a position where a remote controller signal of the luminaire is easily received, for example, on a lower surface side.

The remote controller receiver can configure the control unit 4 to be capable of switching a light color when desired. The remote controller receiver can be configured to enable the user to select a desired value as a color temperature of an optical output of the luminaire in a one-touch operation or continuously change the color temperature and, when a desired light color is obtained, stop the change and select the color temperature.

The auxiliary lamp 5 includes an LED. The LED is lit at a color temperature close to the color temperature of the second light source. A light emission color of the LED is, for example, warm yellow. Therefore, alight color difference is little when the LED is lit following the fadeout mode. A sense of discomfort is not caused.

The auxiliary lamp lighting circuit 6 obtains direct-current power from the direct-current power supply 3c included in the lighting circuit 3 for the first and second light sources 1 and 2 to operate and lights the auxiliary lamp 5. Reference sign DSG3 in FIG. 1 denotes a driving signal generating circuit that generates a driving signal supplied to a switching element of the auxiliary lamp lighting circuit 6. The driving signal generating circuit is controlled by the control unit 4.

Further, the control unit 4 performs control explained below concerning lighting of the auxiliary lamp 5. That is, the control unit 4 selectively controls lighting and extinguishing every time on the basis of operation by the user. In the fadeout mode, the control unit 4 continues to light the auxiliary lamp 5 at the end of the fadeout mode. However, the control unit 4 may be configured to switch the auxiliary lamp 5 not to be lit when desired.

### Second Embodiment

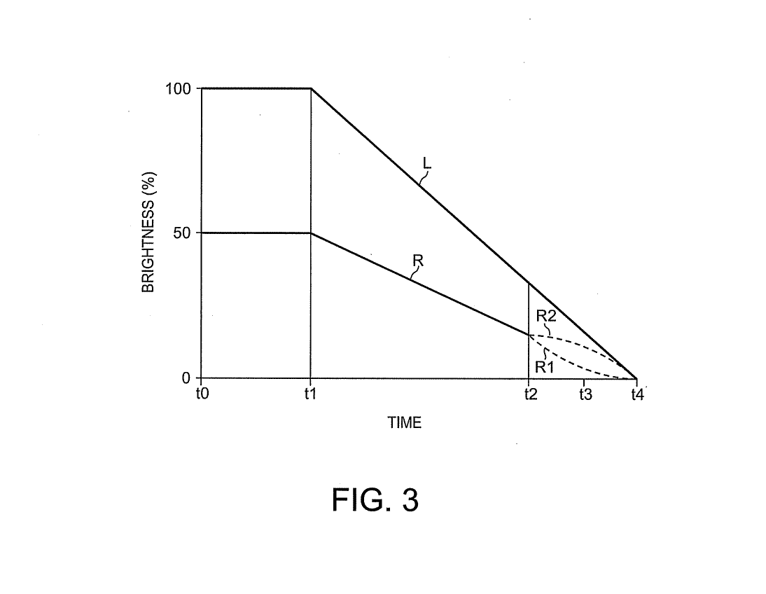

A second embodiment is explained with reference to FIG. 3. In the figure, portions same as those in FIG. 2 are denoted by the same reference signs and explanation of the portions is omitted. In this embodiment, a dimming mode of the first and second light sources 1 and 2 in the fadeout mode is different from that in the first embodiment.

That is, the first and second light sources 1 and 2 are continuously lit until the end of the fadeout mode throughout the periods of the former half and the latter half of the later stage of the fadeout mode. However, while the first and second light sources 1 and 2 are lit, a light amount of the second light source 2 is controlled to be always larger than a light amount of the first light source 2.

In the second embodiment, a sudden change does not occur in a color temperature of an optical output of a luminaire throughout the entire period of the fadeout mode. That is, the color temperature gently drops naturally in the period of the latter stage of the fadeout mode.

An embodiment of the luminaire is explained. The luminaire includes a luminaire main body and a light source lighting device according to the embodiment explained above disposed in the luminaire main body . In the above explanation, the luminaire is allowed to be various apparatuses including the first and second light sources. The luminaire main body refers to a portion remaining after the light source lighting device is excluded from the luminaire. The light source lighting device is the embodiment explained above. The lighting circuit may be disposed in a position away from the luminaire main body.

According to the embodiments of the present invention, when a light including the first and second light sources in a room is toned or toned and dimmed, a light amount of the second light source is increased to be larger than a light amount of the first light source in the period of the latter stage of the fadeout mode. Consequently, since a color temperature of indoor illumination light drops, it is possible to obtain an effect that the toning and the dimming can be performed without discontinuity of the toning and the dimming recognized by a person.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

### CITATION OF RELATED APPLICATION

This application is based upon and claims the benefit of priority from prior Japanese Patent Application No. 2010-254317 filed on Nov. 12, 2010, the entire contents of which are incorporated herein by reference.

### REFERENCE SIGNS LIST

1 First light source

2 Second light source

3 Lighting circuit

3a First lighting circuit element

3b Second lighting circuit element

3c Direct-current power supply

4 Control unit

5 Auxiliary lamp

6 Auxiliary lamp lighting circuit

DSG2, DSG2, DSG3 Driving signal generating circuits

IF1, IF2, IF3, IF4 Interfaces

RCS Remote controller signal

1. A light source lighting device comprising:
a first light source;
a second light source having color temperature lower than a color temperature of the first light source, the color temperature of the second light source being 2500˜3200 K;
a lighting circuit configured to light each of the first and second sources; and
a control unit having a fadeout mode, for continuously dimming and fading out both the first and second light sources, and having periods of a former stage and a latter stage which controls the lighting circuit to increase a light amount of the second light source to be larger than a light amount of the first light source.

2. The light source lighting device according to claim 1, wherein the color temperature of the first light source is 4600˜5400 K.

3. The light source lighting device according to claim 1, further comprising an auxiliary lamp configured to be lit at a color temperature closed to the color temperature of the second light source compared with the color temperature of the first light source after execution of the fadeout mode.

4. The light source lighting device according to claim 1, wherein an optical output of the first light source is reduced greater than an optical output of the second light source in a period of a former half of the latter stage of the fadeout.

5. The light source lighting device according to claim 1, wherein the control unit continuously lights the first and second light sources until an end of the fadeout mode throughout periods of a former half and a latter half of the latter stage of the fadeout mode, and during the time, controls the light amount of the second light source to be always larger than the light amount of the first source.

6. A luminaire comprising:
a luminaire main body; and
the light source lighting device according to claim 1 disposed in the luminaire main body.

7. A luminaire comprising:
a luminaire main body; and
the light source lighting device according to claim 5 disposed in the luminaire main body.
